(19) United States
(12) Patent Application Publication
(10) Pub. No.: US 2020/0290798 A1
(43) Pub. Date: Sep. 17, 2020

(54) RECEPTACLE AND ITS METHOD OF MANUFACTURE

(71) Applicant: PHILBIN PRODUCTS LIMITED, Burton, Neston Cheshire (GB)

(72) Inventor: Philip SUTTON, Burton, Neston Cheshire (GB)

(21) Appl. No.: 15/775,095

(22) PCT Filed: Nov. 11, 2016
(86) PCT No.: PCT/GB2016/053536

§ 371 Date: May 10, 2018

(30) Foreign Application Priority Data
Nov. 13, 2015 (GB) 1520100.7

(51) Int. Cl. B65F 1/06; B65F 1/16

(52) U.S. Cl. CPC B65F 1/068; B65F 1/1615; B65F 1/163; B65F 1/1646; B65F 2210/1026; B65F 2210/129; B65F 2210/132; B65F 2230/152; B65F 2250/1146; B65F 2250/116; B65F 2210/13

(57) ABSTRACT

The receptacle includes an outer body, one end of the outer body forming a base, the other end of the outer body forming a rim extending inwardly from the periphery of the outer body, and at least one inner waste containing compartment extending inwardly and downwardly from the rim. The outer body, rim and at least one inner waste containing compartment are integrally formed.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention relates to a receptacle and its method of manufacture. In particular, this invention relates to a waste receptacle that has few component parts and, as such, can be manufactured quickly and easily. This invention is particularly, but not exclusively, applicable to the temporary storage of domestic and household waste in a number of aesthetically pleasing and hygienic arrangements. This invention can be configured with one or more separate sections or collection compartments which enables refuse to be sorted into waste intended for landfill and recyclables.

### 2. Description of Related Art Including Information Disclosed Under 37 CFR 1.97 and 37 CFR 1.98.

Waste receptacles for temporarily storing and containing domestic refuse have been known for many years. There are a plethora of waste receptacles or refuse bins available in the marketplace that each have the same general design. Prior art refuse bins are generally formed as an open receptacle from a hard plastics material and having a lip around which a refuse bag can be secured, and usually a separate or hinged lid to close the open receptacle to prevent or reduce odours. Alternatively, refuse bins can be formed from sheet metal, usually stainless steel, which is rolled or shaped using conventional workshop techniques to form an outer structural wall into which a removable plastics liner or polythene refuse bag can be retained.

These known refuse bins have not coped well with the relatively recent restrictions imposed upon householders that domestic refuse has to be separated into different streams, i.e. waste intended for landfill and recyclables, for collection. Most domestic kitchen environments will now often contain two or more waste receptacles. Prior art waste receptacles of this type can occupy a considerable amount of floor space in a room that is commonly held to be getting smaller in new build developments and conversions. It is likely that the householder will be required in future to separate refuse into further different streams to prevent other recyclables from entering landfill, and this problem of a lack of floor space will be further exasperated.

In order to address this problem there are several proprietary dual or twin receptacle refuse bins are available in the marketplace, and other recycling refuse bins or cabinets have been developed. Such known recycling refuse bins can take various forms in order to save space, but are often difficult to use, cumbersome to empty and have limited capacities. The vast majority of these known recycling refuse bins are formed having a sheet metal outer structural wall into which a removable compartmentalised plastics liner, or separate liners, are retained.

This construction leads however to small gaps or openings between the compartmentalised plastics liner, or separate liners, and the structural outer wall in which they are seated. These gaps can be difficult to clean, and can lead to a build up of refuse, dirt and grime which is both unhygienic and can be a source of odour. It is often difficult to access one of the two compartments without disturbing or opening the other, which can lead to cross contamination of refuse.

These bins are also time-consuming to manufacture, having many component parts, and hence are expensive to produce. Having an outer wall formed from sheet metal generally limits the geometric shape of the waste collector to circular or rectangular arrangements. Outer metal wall bins are subjected to careless handling and consequent damage, which can be unsightly.

It is an object of the present invention to provide a receptacle and its method of manufacture which overcomes or reduces the drawbacks associated with known products of this type. The present invention provides a waste receptacle having a unitary construction, with an outer aesthetic body integrally moulded with one or more inner waste collection compartments. Each of the inner waste collection compartments having a greater taper angle than known waste receptacles to aid refuse bag removal, and is closed off with a lid. It is a further object of the present invention to provide a waste receptacle that is quick and easy to manufacture from few component parts and which leads to an aesthetically pleasing and durable product. Sharp edges and gaps are eliminated to facilitate cleaning and to reduce the risk of damage or entrapment of the refuse bag in use. It is a further object of the present invention to provide a waste receptacle having two or more inner waste collection compartments which enables the householder to sort refuse into waste intended for landfill and recyclables. It is a further object of the present invention to provide a waste receptacle having inner waste collection compartments that are tapered inside a stable unitary body that facilitates ease of emptying the refuse bag.

### BRIEF SUMMARY OF THE INVENTION

The present invention is described herein and in the claims.

According to the present invention there is provided a receptacle comprising an outer body, one end of the outer body forming a base, the other end of the outer body forming a rim extending inwardly from the periphery of the outer body, and at least one inner waste containing compartment extending inwardly and downwardly from the rim, wherein the outer body, rim and at least one inner waste containing compartment being integrally formed.

An advantage of the present invention is that it can be quickly and easily manufactured from few component parts and which leads to an aesthetically pleasing and durable waste receptacle. Such an integrally moulded receptacle eliminates tight corners and gaps and hence improves hygiene and significantly reduces the risk of damaging the refuse bag in use.

Preferably, the body is formed as a generally hollow cylindrical or trilobular-shaped body.

Further preferably, one end of the body comprises a substantially flat continuous cross section which forms a base.

In use, the other end of the body may be formed as a substantially flat continuous annular or trilobular-shaped rim which extends inwardly around the periphery of the body.

Preferably, the rim defines an opening through which refuse is placed into the inner waste collection compartment in use.

Further preferably, the opening in the body is closed off by a removable hinged lid.

In use, the inner waste collection compartment may be enveloped inside the body.

Preferably, the inner waste collection compartment is formed coaxially with the body.

Further preferably, the body, rim and inner waste collection compartment are seamlessly moulded.

In use, the inner waste collection compartment may extend inwardly from the rim along an inclined shoulder which transitions to a tapered side wall that gradually narrows to a radiused corner forming a substantially flat-bottomed base.

Preferably, the shape of the rim, inclined shoulder, tapered side wall and radiused corner are each profiled so as to reduce the risk of damaging a refuse bag in use.

Further preferably, the removable hinged lid is integrally formed with a refuse bag retaining collar.

In use, the inner waste collection compartment may be convergent with the body.

Preferably, the inner waste containing compartment is formed having a generally frustoconical shape.

Further preferably, the angle formed by the intersection of the tapered side wall and the body is between around 2° to 8°.

In use, the angle formed by the intersection of the tapered side wall and the body may be around 5°.

Preferably, the capacity of the inner waste containing compartment is between around 15 litres to 45 litres.

Further preferably, the capacity of the inner waste containing compartment is around 30 litres.

In use, the height of the receptacle may be around 672 mm; the internal diameter of the rim may be around 340 mm; and the diameter of the generally flat-bottomed base may be around 305 mm.

Preferably, the seamless moulding of the body, rim and inner waste collection compartment prevents the build-up or ingress of refuse, dirt and/or bacteria.

Further preferably, the hinged lid and retaining collar is removable for cleaning and/or is dishwasher safe.

In use, the receptacle may be formed using injection moulding tools and/or processes.

Preferably, the hinged lid and retaining collar is formed using injection moulding tools and/or processes.

Further preferably, the receptacle and/or the hinged lid and retaining collar is formed from homo- or copolymer polypropylene.

In use, the receptacle and/or the hinged lid and retaining collar may be formed from a synthetic plastics material and/or a thermoplastic and/or thermoset material and/or from a blend of recycled polymers from both postindustrial and domestic waste streams.

Preferably, the blend of recycled polymers is around 50% of the plastics material.

Further preferably, the receptacle and/or the hinged lid and retaining collar is formed via injection moulding and/or blow moulding and/or vacuum forming and/or rotational moulding and/or compression moulding and/or rim moulding and/or power impression moulding and/or any form of plastics manufacture.

In use, the outer surface of the body and/or rim and/or the hinged lid and retaining collar may comprise a low VDI (Vereines Deutscher Ingenieure) textured finish.

Preferably, the low VDI (Vereines Deutscher Ingenieure) textured finish is between around 12 to 45 on the VDI scale.

Further preferably, the internal bore of the inner waste collection compartment comprises a highly polished surface finish.

In use, the highly polished surface finish may be less than around 12 on the VDI scale.

Preferably, the generally flat-bottomed base comprises one or more openings for receiving one or more removable drainage plugs.

Further preferably, the removable drainage plugs allow for ease of cleaning in use and/or enable air displaced in the inner waste collection compartment to be vented when changing the refuse bag in use.

In use, the removable drainage plugs are provided as push-fit caps.

Preferably, the receptacle further comprises a base plate to be retained inside the base of the body.

Further preferably, the base plate comprises a plurality of projections which meet with corresponding apertures disposed in the substantially flat-bottomed base.

In use, the base plate may further comprise one or more finger apertures or slots to facilitate removal and subsequent reattachment of the base plate to the base of the body.

Preferably, the base plate is releasably secured to the base of the body using a fastener selected from the group consisting, but not limited to, any one of the following: circumferential screw thread, bayonet attachment, threaded fastener and clip.

Further preferably, the refuse bag retaining collar comprises a tapered flat ring or collar which is complementary in shape to the inner waste collection compartment.

In use, the refuse bag retaining collar may be engageable inside the shoulder of the inner waste collection compartment to secure the refuse bag in use.

Preferably, the refuse bag retaining collar comprises at least two finger grips to aid removal of the retaining collar from the receptacle in use.

Further preferably, the refuse bag retaining collar comprises a plurality of protrusions disposed around the outer circumference of the retaining collar, the protrusions being engageable with a complementary plurality of cut-out sections in-moulded around the inclined shoulder of the inner waste collection compartment.

In use, the refuse bag retaining collar may comprise a continuous or semi-continuous lip formed around the periphery of the retaining collar which abuts against the lid in a closed configuration.

Preferably, the refuse bag retaining collar is pivotally connected to the lid by hinge means, the hinge means enabling damped pivotal or rotational movement of the lid from the closed configuration to an open configuration when a lid release catch is depressed.

Further preferably, the hinge means enables the speed of the pivotal or rotational movement to be adjusted and/or controlled.

In use, the hinge means may be selected from the group consisting, but not limited to, any one of the following: torsional spring arrangement, rotational coupling, rolling bearing, hinge, pivot and mechanical linkage.

Preferably, the receptacle further comprises one or more horizontal slots in-moulded around the inclined shoulder of the inner waste collection compartment.

Further preferably, the one or more horizontal slots forming at least one pocket into which any excess refuse bag material can be gathered to ensure that the refuse bag is form fitting in use.

In use, the one or more horizontal slots may be dimensioned to act as carry handles.

Preferably, the receptacle further comprises a removable activated carbon filter cassette securable inside a complementary shaped retaining means formed under the hinged lid.

Further preferably, the removable activated carbon filter cassette is accessed through the lid of the receptacle.

In use, the removable activated carbon filter cassette may be formed as sealed unit having apertures which vent an activated carbon ingredient to atmosphere.

Preferably, the body defines two separate and adjacent inner waste collection compartments.

Further preferably, the body is formed having a cross section that is selected from the group consisting, but not limited to, any one of the following: oval, parabolic, circular, ellipsoidal, square and rectangular.

In use, each of the inner waste collection compartments may be circular and/or trilobular and/or rectangular and/or square in cross section, and each of the inner waste collection compartments being enveloped inside the body.

Preferably, the rim separates the adjacent inner waste collection compartments and has an aesthetically pleasing swept profile.

Further preferably, the capacity of each the two inner waste containing compartment is around 30 litres, and forming a receptacle having a total capacity of around 60 litres.

In use, each of the two inner waste containing compartments may be circular in cross section, the height of the receptacle may be around 672 mm; the internal diameter of the annular rim may be around 340 mm; and the diameter of the generally flat-bottomed base may be around 305 mm.

Preferably, each of the two inner waste containing compartments are trilobular in cross section, the height of the receptacle is around 672 mm; the internal width of the trilobular aperture formed in the rim is around 333 mm; the internal length of the trilobular aperture formed in the rim is around 289 mm; the width of the radiused corner and substantially flat-bottomed trilobular base is around 226 mm; and the length of the radiused corner and substantially flat-bottomed trilobular base is around 190 mm.

Further preferably, the hinged lid is colour coded to signify the refuse material to be placed therein.

Also according to the present invention there is provided a method of manufacturing a receptacle, comprising the steps of:

supplying a polymer into a moulding tool which defines a body having at least one inner waste containing compartment, the moulding tool including a textured surface finish on the outer surface of the body and a polished surface finish on the inner surface of the at least one inner waste collection compartment; and

ejecting the moulded receptacle from the moulding tool.

Preferably, the polymer includes a blend of recycled polymers from both postindustrial and domestic waste streams.

Further preferably, the method further comprises the step of admixing an antimicrobial additive with the polymer.

It is believed that a receptacle and its method of manufacture in accordance with the present invention at least addresses the problems outlined above.

It will be obvious to those skilled in the art that variations of the present invention are possible and it is intended that the present invention may be used other than as specifically described herein.

### BRIEF DESCRIPTION OF THE SEVERAL VIEWS OF THE DRAWINGS

The present invention will now be described by way of example only, and with reference to the accompanying drawings.

FIG. 1 is a perspective view from the side and above of the receptacle in accordance with the present invention.

FIG. 2 shows a cutaway sectional view from the side of the receptacle of FIG. 1 along the line A to A′.

FIG. 3 illustrates the cutaway sectional view of FIG. 2 and showing further detail of a base plate to increase the rigidity of the receptacle in use.

FIG. 4 is an exploded perspective view from the side and above of the receptacle of FIG. 1 and showing further detail of how a refuse bag is retained inside the inner waste collection compartment using an integral bag retaining collar and hinged closure lid.

FIG. 5 shows an exploded perspective view from the side and above of the receptacle of FIG. 1 and showing further detail of the integral bag retaining collar and hinged closure lid.

FIG. 6 illustrates a perspective view of a section under the hinged closure lid of the receptacle of FIG. 5 and showing further detail of an in-moulded activated carbon filter to reduce odours in use.

FIG. 7 is a perspective view from the side and above of a second embodiment of the present invention which is configured having two adjacent inner waste collection compartments which make it is easy for the householder to sort recyclables from their domestic waste.

FIG. 8 shows a cutaway sectional view from the side and above of the dual recycling receptacle shown in FIG. 7 along the line B to B′.

FIG. 9 illustrates a perspective view from above of the dual recycling receptacle of FIG. 7 and showing the tapered inner waste collection compartments that allows ease of removal of the refuse bag in use.

FIG. 10 is a top plan view from above of the dual recycling receptacle of FIG. 7.

FIG. 11 shows a perspective view from the side and above of a third embodiment of the present invention which is which is configured having two adjacent inner waste collection compartments, each compartment having a trilobular cross section.

FIG. 12 illustrates a perspective view from above of the dual recycling receptacle of FIG. 11 and showing both of the closure lids removed from the inner waste collection compartments to reveal horizontal slots into which any excess refuse bag material can be gathered to ensure that the refuse bag is form fitting in use.

FIG. 13 is a top plan view from above of the dual recycling receptacle of FIG. 11.

FIG. 14 is a perspective view from the side and above of the receptacle of FIG. 1 and showing further detail of the bag retaining collar and closure lid.

FIG. 15 shows a perspective view from the rear side and below of the receptacle shown in FIG. 14 and illustrates that the base section of the inner compartment can include a plurality of supporting feet.

FIG. 16 illustrates a perspective view from the rear side and below of the bag retaining collar which includes a plurality of engagement features for location and securement of the collar inside the inner compartment when in use.

FIG. 17 is a perspective view from the side and above of the open waste receptacle without the integral bag retaining collar and hinged closure lid in place, and shows further detail of the slots that are in-moulded inside the rim and into which any excess refuse bag can be “tucked in” or “tucked away” before the retaining collar is located in position.

FIGS. 18 and 19 show an exploded perspective view and an assembled perspective view, respectively, of the bag retaining collar and hinged closure lid and illustrates how the damped hinged lid is opened and closed via a touch lid catch mechanism.

FIG. 20 shows a cutaway sectional view of the integral bag retaining collar and hinged closure lid along the line A to A′ of FIG. 1.

### DETAILED DESCRIPTION OF THE INVENTION

The present invention has adopted the approach of utilising a waste receptacle having a unitary construction with an outer aesthetic body integrally moulded with one or more inner waste collection compartments. Each of the inner waste collection compartments having a greater taper angle than known waste receptacles to aid refuse bag removal, and is closed off with a lid. Advantageously, the present invention provides a waste receptacle that is quick and easy to manufacture from few component parts and which leads to an aesthetically pleasing and durable product. Further advantageously, sharp edges and gaps are eliminated to facilitate cleaning and to reduce the risk of damage or entrapment of the refuse bag in use. Further advantageously, the present invention provides a waste receptacle having two or more inner waste collection compartments and which enables the householder to sort refuse into waste intended for landfill and recyclables. Further advantageously, the present invention provides a waste receptacle having inner waste collection compartments that are tapered inside a stable unitary body that facilitates ease of emptying the refuse bag.

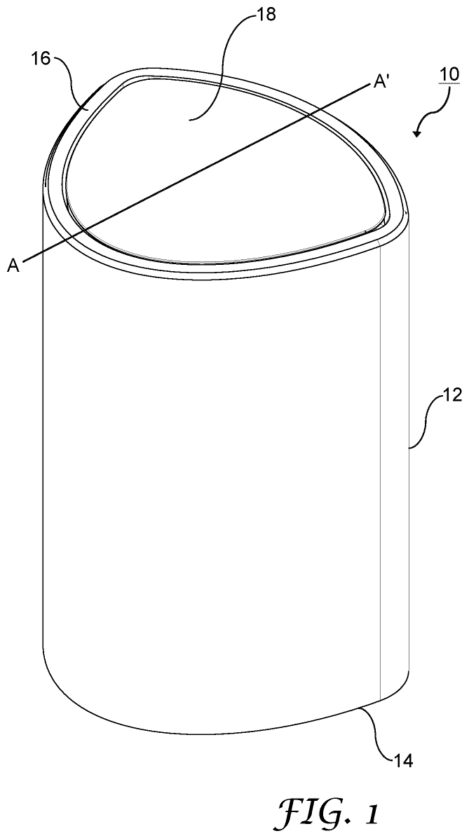

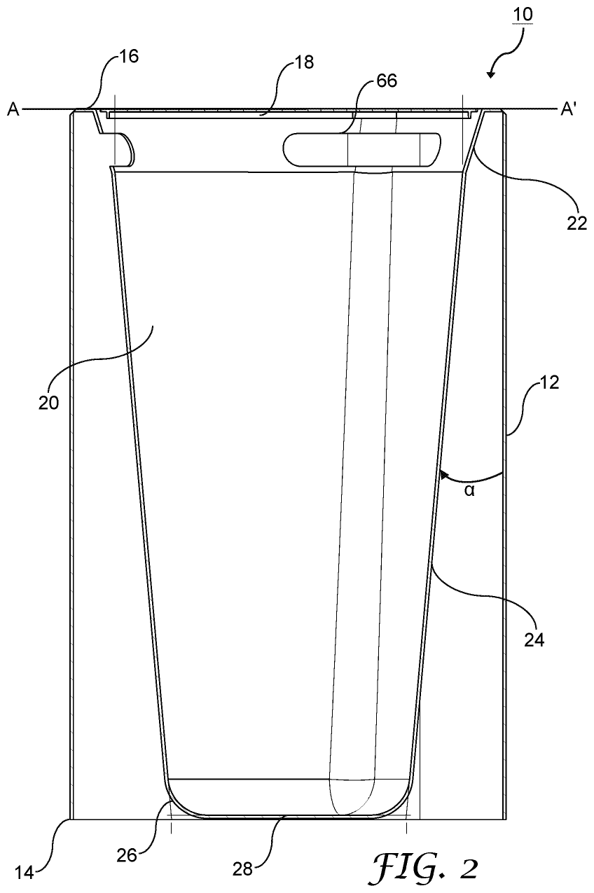

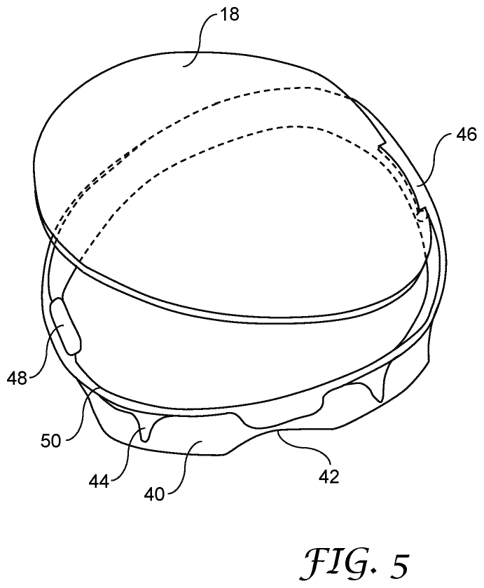

Referring now to the drawings, a waste receptacle 10 according to the present invention is shown in FIGS. 1 and 2. Specifically, the receptacle 10 is formed as a generally hollow cylindrical or trilobular body 12. One end of the body 12 has a substantially flat continuous cross section which forms a base 14. The other end of the body 12 is formed as a substantially flat continuous annular or trilobular rim 16 which extends inwardly around the periphery of the body 12. The rim 16 defines an opening through which refuse is placed into an inner waste collection compartment 20 formed coaxially inside the outer body 12. The opening in the body 12 can be closed off by a removable hinged lid 18, further detail of which is illustrated in FIG. 5. The cylindrical or trilobular body 12, rim 16 and inner waste collection compartment 20 are all seamlessly moulded having a unitary construction that leads to the advantageous effects of the invention.

FIG. 2 shows the receptacle 10 of FIG. 1 in a cutaway section along the line A to A′. The unitary construction of the outer body 12, rim 16 and inner waste collection compartment 20 are evident from the cross sectional view shown in FIG. 2.

The inner waste collection compartment 20, which is enveloped coaxially inside the outer body 12, extends from the rim 16 along an inclined shoulder 22 which then defines a tapered side wall 24 that gradually narrows to a substantially flat-bottomed base 28. The substantially flat-bottomed base 28 meets with the tapered side wall 24 via radiused corner 26.

The profile of the shoulder 22, tapered side wall 24 and radiused corner 26 are designed so as to reduce the risk of tearing a refuse bag (not shown in FIG. 2 for clarity) in use. The inner waste collection compartment 20 is convergent with the outer body 12 and is formed having a generally frustoconical shape tapering to the generally flat-bottomed base 28.

In a preferred embodiment, the angle formed by the intersection of the tapered side wall 24 and the body 12, and denoted as angle α in FIG. 2, is around 5°. This is in no way intended to be limiting as any number of different taper angles are envisaged. The taper angle formed by the intersection of the tapered side wall 24 and the body 12 can be in the region of 2° to 8°.

FIG. 2 shows a waste receptacle 10 having a 30 litre capacity, although this is in no way intended to be limiting as the receptacle 10 can be dimensioned in any number of capacities, from as small as 15 litres to a large capacity 45 litre refuse bin.

As best shown in FIG. 2, the unitary construction of the body 12, rim 16 and inner waste collection compartment 20 ensures that there are no gaps, joins or fasteners which might otherwise permit the build-up or ingress of refuse, dirt or bacteria. The receptacle 10 of the present invention is easy to clean, and the lid 18 can be completely removed for cleaning, for example, in a dishwasher. The present invention therefore is very hygienic in use, minimising the transfer of germs and bacteria which could otherwise be detrimental to health. By moulding the inner waste collection compartment 20 and outer body 12 as one piece vastly reduces the number of component parts and minimises the risk of inherent component damage when removing the refuse bag (not shown in FIG. 2) to change it.

In order to further diminish the risk of cross-infection or the transfer of germs and bacteria by touch, it is envisaged that an antimicrobial additive, such as silver ions, could be admixed with the injection moulding polymer forming the moulded receptacle 10 and/or the hinged lid 18 and/or retaining collar 40.

In a preferred embodiment, for a 30 litre refuse bin, the height of the waste receptacle 10 is around 672 mm. The internal diameter of the rim 16 is 340 mm, and the diameter of the generally flat-bottomed base 28 is 305 mm.

The waste receptacle 10 of the present invention is formed using injection moulding. In a preferred embodiment, the receptacle 10 is formed from homo- or copolymer polypropylene, although the skilled person will appreciate that the waste receptacle 10 can be formed from a number of synthetic plastics material such as a thermoplastic or thermoset material, or any other suitable first or second generation plastics material. The above list is in no way intended to be limiting and exhaustive.

The skilled person will appreciate that certain components or sections could be manufactured with the use of both injection moulded components and rotational components, or compression moulded or blow moulded parts, if so required. Different variations or densities of materials could also be provided. Manufacturing some or all of the components of the waste receptacle 10 using injection moulding will allow for a relatively thin wall thickness and a generally low product weight which provides a high structural rigidity and durability. The manufacture of the receptacle 10 resists dents and dints in use, and provides an outer surface that is fingerprint resistant.

The receptacle 10 can be further manufactured using other techniques such as blow moulding, vacuum forming, rotational moulding, compression moulding, rim moulding, power impression moulding or any form of plastics manufacture. The receptacle 10 can be manufactured from a blend of recycled polymers from both postindustrial and domestic waste streams. In a preferred embodiment, the receptacle 10 can be manufactured having up to 50% by weight recycled polymer relative to the total polymer content. The amount of recycled polymer can be as high as 75% by weight relative to the total polymer content, or even 100% by weight recycled polymer relative to the total polymer content.

In a preferred embodiment, to obtain a fingerprint resistant outer surface finish on the outer surface of the body 12, rim 16 and/or removable hinged lid 18, the injection moulding tool includes a low VDI (Vereines Deutscher Ingenieure) textured finish. The textured surface finish on the outer surface of the body 12, rim 16 and/or removable hinged lid 18 is preferably in the region of 12 to 45 on the German VDI scale of surface textures.

The internal bore of the inner waste collection compartment 20 is however moulded with a highly polished surface to reduce friction and to reduce the risk of damage to the refuse bag (not shown in FIG. 2 for clarity) in use. The internal bore of the inner waste collection compartment 20 is manufactured having a surface finish preferably less than around 12 on the German VDI scale of surface textures.

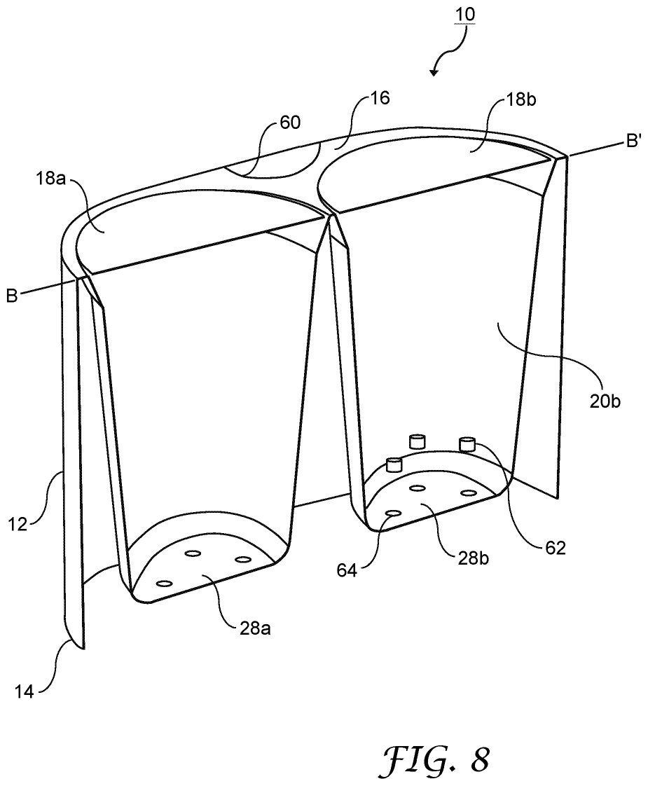

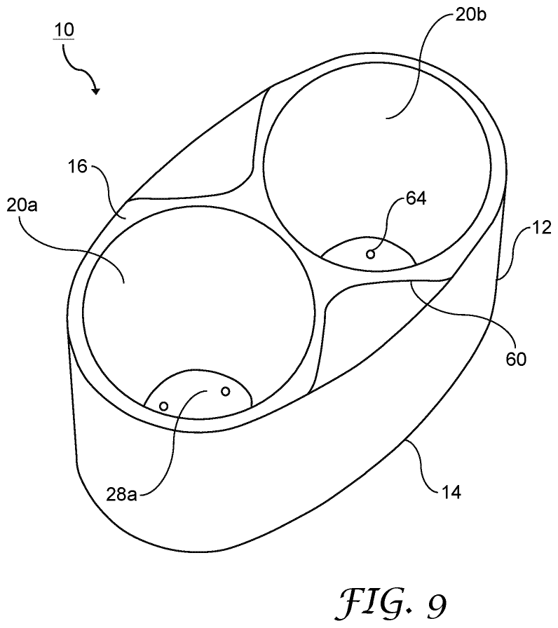

Whilst not shown in FIG. 2 for reasons of clarity, the generally flat-bottomed base 28 includes one or more drainage plugs which can be removed from their respective openings (not shown) in the flat-bottomed base 28. The drainage plugs allow for ease of cleaning in use and also aid with venting of the air displaced in the inner waste collection compartment 20 when changing the refuse bag (not shown in FIG. 2 for clarity) in use. Further detail of these features is shown in FIGS. 8 and 9.

The waste receptacle 10 of the present invention offers the additional advantage that at the end of the product's usable life, the few separate components forming the receptacle 10 can be easily disassembled and separated for recycling and/or reuse.

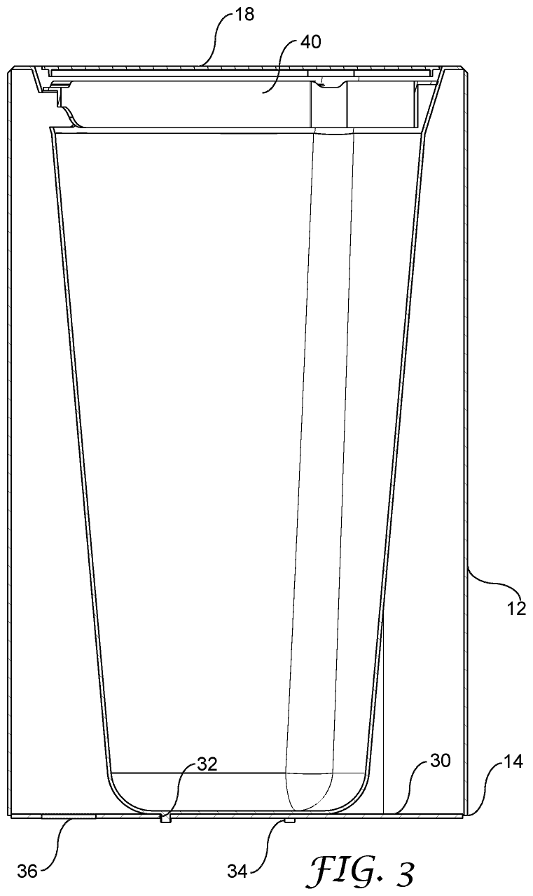

Whilst FIG. 2 shows the design of the receptacle 10 having an open base 14, it is possible to further increase the rigidity of the receptacle by including a separate base plate 30 that can be retained inside the open base 14. Further detail of this is shown in FIG. 3 which shows a cutaway section of the receptacle 10 meeting with the separate base plate 30. FIG. 3 shows that a number of apertures 32 in the substantially flat-bottomed base 28 meet with corresponding projections 34 in the separate base plate 30. Alternatively, a plurality of snap-fit indents can be disposed around the inner periphery of the base 14 of the outer body 12. The plurality of snap-fit indents meet with, and attach to, a corresponding plurality of snap-fit protrusions or protuberances disposed on the base plate 30. One or more finger apertures or slots 36 are provided in the base plate to facilitate removal and subsequent reattachment of the base plate 30 to the base 14 of the outer body 12.

Whilst the apertures 32 and complementary protuberances 34 described herein in relation to FIG. 3 are used to remove or attach the base plate 30 in use, the skilled person will appreciate that any form of fastening or attachment is possible, including, for example, circumferential screw thread, bayonet attachment, securement by separate threaded fasteners, clips and other means etc. The above list is in no way intended to be limiting and exhaustive.

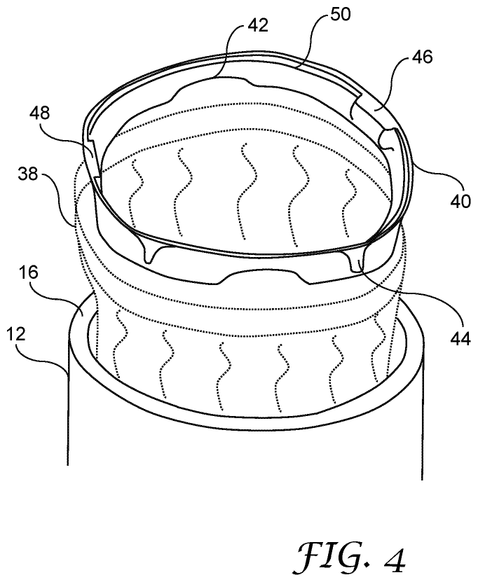

FIG. 4 shows an exploded view of the waste receptacle 10 of FIG. 1, but showing further detail of how a refuse bag 38 is retained therein. In particular, FIG. 4 shows that a complementary shaped removable tapered retaining ring 40 is used to secure the refuse bag 38 safely in position around the shoulder 22 of the inner waste collection compartment 20. The tapered retaining ring 40 is very generally configured as a flat ring or collar which is trilobular or circular in cross section and complementary in shape to the inner waste collection compartment 20. In the embodiment described and shown in FIGS. 1 to 3 and 11 to 13, the tapered retaining ring 40 is trilobular in cross section.

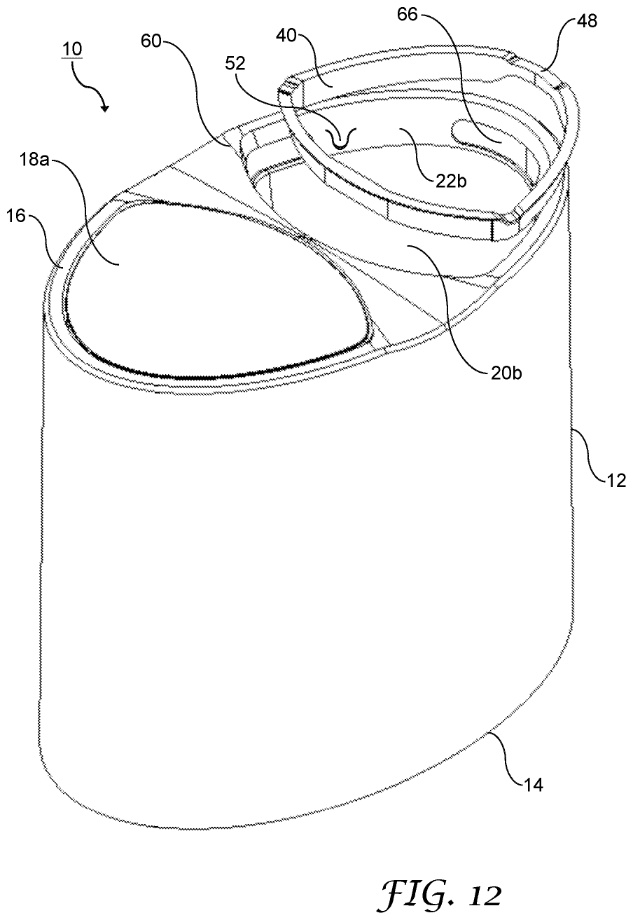

The tapered retaining ring 40 includes at least two finger grips 42 to aid removal from the waste receptacle 10. A plurality of V-shaped protrusions 44 are disposed around the outer circumference of the retaining ring 40 which locate simply within a plurality of V-shaped cut-out sections 52 which are in-moulded around the inclined shoulder 22 towards the top of the inner waste collection compartment 20, as best shown in FIG. 12. Although the protrusions 44 on the retaining ring 40, and complementary cut-out sections 52 that are in-moulded at the top of the inner waste collection compartment 20, are shown as V-shaped in FIGS. 5 and 12, this is in no way intended to be limiting as these engagement features can be implemented in any number of complementary geometric shapes or forms.

As best shown in FIG. 5, the hinged closure lid 18 is integrally formed with the retaining ring 40, which includes a hinge block 46 and lid release catch 48. The hinge block 46 provides a damped rotational movement when the lid release catch 48 is depressed. The hinge block 46 allows the lid 18 to be positioned in a fully opened 90° vertical position and also the speed of the opening motion can be fully adjusted. In use, the lid 18 closes against a continuous lip 50 formed around the periphery of the retaining ring 40. As with the receptacle 10, the lid 18 and retaining ring 40 of the present invention are also formed using injection moulding.

The skilled person will appreciate that the operation of the closure lid 18 can alternatively be controlled using a foot pedal mechanism and linkage (not shown).

The damped rotational movement provided by hinge block 46 is achieved using a torsional spring configuration.

The shape and smooth surface of the tapered inner waste collection compartment 20 allows for ease of evacuation of the filled refuse bag 38 that is held by the retaining ring 40. By having a generally frustoconical shape, the refuse bag 38 can be easily removed, and all tight corners are eliminated from around the rim 16, shoulder 22, tapered side wall 24 and radiused corner 26, which significantly reduces the risk of damaging the refuse bag 38.

The present invention can be used with any suitable proprietary refuse bag 38 available in the marketplace.

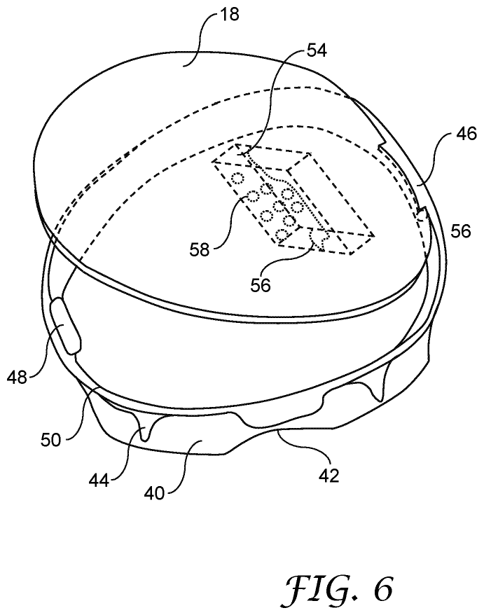

FIG. 6 illustrates a section under the hinged closure lid 18 of the receptacle 10 of FIG. 5, and shows how an activated carbon filter cassette 54 can be used reduce odours in use. The separate activated carbon cassette 54 is held in place inside a complementary shaped pocket 56 formed under the closure lid 18. The activated carbon cassette 54 is formed as sealed unit with apertures 58 which vent the activated carbon ingredient to atmosphere. Changing the cassette 54 is simply achieved by opening the closure lid 18 and removing and discarding the used cassette 54 and then inserting a new cassette inside the complementary shaped pocket 56 or other releasable securement means.

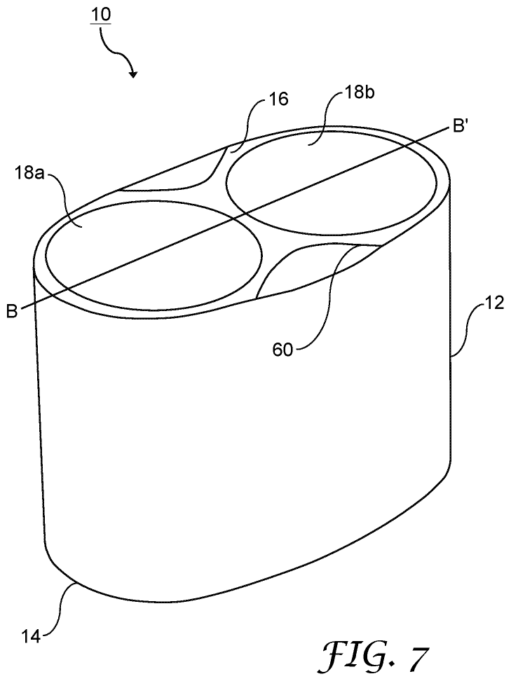

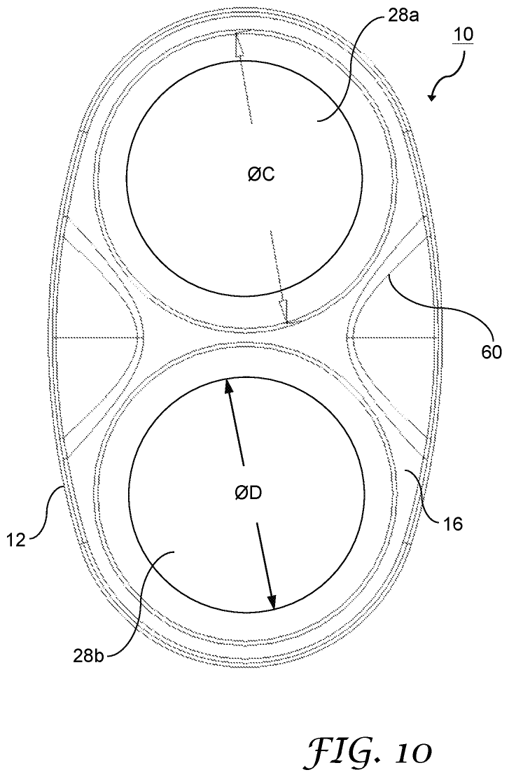

FIGS. 7 to 10 shows a second embodiment of the receptacle 10. The construction of the second embodiment is very similar to that of the first embodiment and corresponding features have been given the same reference numerals. The second embodiment differs from the first embodiment in that the waste receptacle 10 is configured to provide two or more inner waste collection compartments 20a, 20b and which enable the householder to sort refuse into two or more different streams of waste, e.g. waste intended for landfill and recyclables. As best shown in FIG. 10, the outer footprint of the body 12 forming the dual recycling receptacle 10 is oval or parabolic in shape. This is in no way intended to be limiting as the dual recycling receptacle 10 can be implemented in any number of ellipsoidal, rectangular or curved geometric shapes.

As with the first embodiment of the invention, the inner waste collection compartments 20a, 20b are both circular in cross section and are enveloped inside the outer body 12. Each of the inner waste collection compartments 20a, 20b extends from the rim 16 situated around the upper surface of the body 12, and each inner waste collection compartments 20a, 20b is formed as an inclined shoulder 22a, 22b which then defines a tapered side wall 24a, 24b that gradually narrows to a substantially flat-bottomed base 28a, 28b. The substantially flat-bottomed base 28a, 28b meets with the tapered side wall 24a, 24b via radiused corner 26a, 26b.

As shown most clearly in FIG. 9, the rim 16, which divides up the adjacent inner waste collection compartments 20a, 20b also has an aesthetically pleasing swept profile 60.

The embodiment shown in FIGS. 7 to 10 shows a shows a dual recycling receptacle 10 having a large 60 litre capacity, and formed having two 30 litre inner waste collection compartments 20a, 20b. The height of the dual recycling receptacle 10 is around 672 mm. The internal diameter of the rim 16, and shown as diameter ∅C in FIG. 10, is 340 mm, and the diameter of the generally flat-bottomed base 28a, 28b, and shown as diameter ∅D in FIG. 10, is 305 mm. Whilst FIGS. 7 to 10 show a dual recycling receptacle 10 having a 60 litre capacity, this is in no way intended to be limiting as the receptacle 10 can be dimensioned in any number of sizes and capacities.

FIG. 7 shows further detail of a feature that can be used on each of the three embodiments of the invention. In particular, the lids 18a, 18b removably attached to outer body 12 can have a colour coding signifying the refuse material to be placed therein. Multiple colours are envisaged, including yellow, red, blue, green and mixtures and shades thereof.

FIGS. 8 and 9 also show further detail of a feature that can be used on each of the three embodiments of the invention, and wherein the generally flat-bottomed base 28a, 28b includes one or more drainage plugs 62 which can be removed from their respective openings 64 in the flat-bottomed base 28a, 28b. The drainage plugs 62 allow for ease of cleaning in use and can also aid with venting of the air displaced in the inner waste collection compartment 20a, 20b when changing the refuse bag (not shown in FIGS. 8 and 9 for clarity) in use. The drainage plugs 62 are provided as push-fit caps that can be retained inside openings 64.

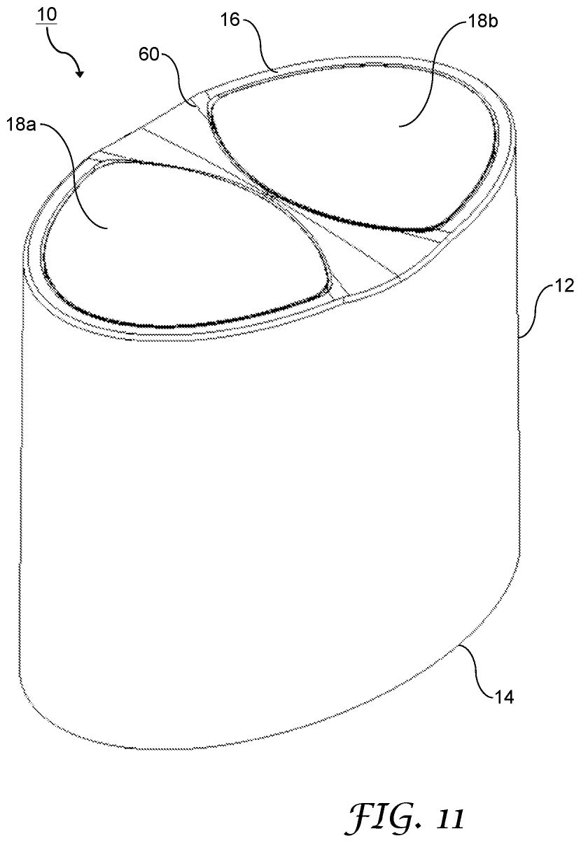

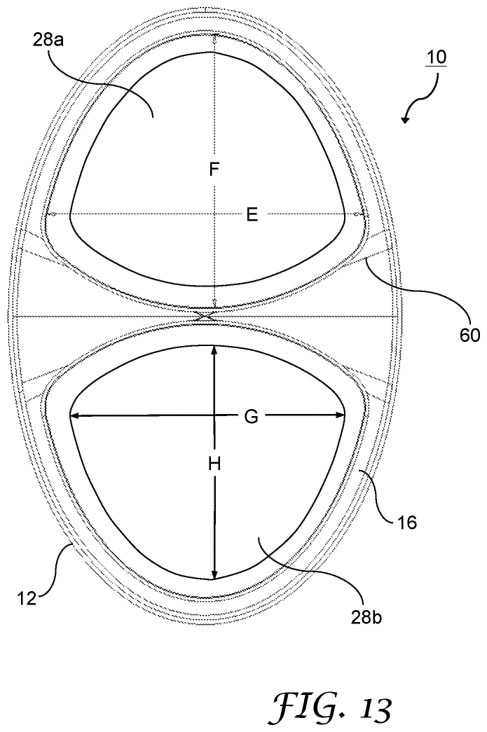

FIGS. 11 to 13 shows a third embodiment of the receptacle 10. The construction of the third embodiment is very similar to that of the second embodiment and corresponding features have been given the same reference numerals. The third embodiment differs from the second embodiment in that the dual recycling receptacle 10 is configured to provide two or more inner waste collection compartments 20a, 20b which are trilobular in cross section for storing two or more different streams of waste. Such a configuration maximises the storage capacity of the two compartments 20a, 20b enveloped in the outer body 12. In particular, and as best illustrated in FIG. 13, the trilobular design lessens the overall footprint of the dual recycling receptacle 10 whilst minimising any tight angles or corners formed around the rim 16, or the shoulder 22a, 22b, tapered side wall 24a, 24b and radiused corner 26a, 26b and so as to reduce the risk of tearing a refuse bag 38 (not shown in FIGS. 11 to 13 for clarity) in use.

FIG. 12 shows further detail of further features that are common to each of the three embodiments of the invention. In particular, FIG. 12 shows how the detachable lid 18a, 18b and tapered retaining ring 40 locate simply within a plurality of V-shaped cut-out sections 52 which are in-moulded around the inclined shoulder 22a, 22b towards the top of the inner waste collection compartment 20a, 20b. It is the interference fit between the tapered retaining ring 40 and the shoulder 22a, 22b that generates enough purchase to hold the refuse bag 38 (not shown in FIG. 12 for clarity) safely in position.

FIG. 12 also shows that one or more horizontal slots 66 are in-moulded around the inclined shoulder 22a, 22b towards the top of the inner waste collection compartment 20a, 20b. These slots 66 form receptacles or pockets into which any excess refuse bag 38 can be “tucked in” before the tapered retaining ring 40 is located in position. These horizontal slots 66 also serve as carry handles when moving the receptacle 10 for cleaning or reposition.

The embodiment shown in FIGS. 11 to 13 shows a shows a dual recycling receptacle 10 having a large 60 litre capacity, and formed having two 30 litre inner waste collection compartments 20a, 20b. The height of the dual recycling receptacle 10 is around 672 mm. The internal width of the trilobular aperture formed in the rim 16, and shown as line E in FIG. 13, is 333 mm. The internal length of the trilobular aperture formed in the rim 16, and shown as line F in FIG. 13, is 289 mm. The width of the trilobular base plate 28a, 28b and radiused corner 26a, 26b, and shown as line G in FIG. 13, is 226 mm. The length of the trilobular base plate 28a, 28b and radiused corner 26a, 26b, and shown as line H in FIG. 13, is 190 mm. Whilst FIGS. 11 to 13 show a dual recycling receptacle 10 having a 60 litre capacity, this is in no way intended to be limiting as the receptacle 10 can be dimensioned in any number of sizes and capacities.

The third embodiment of the invention, as depicted in FIGS. 11 to 13, which utilises inner waste collection compartments 20a, 20b which are trilobular in cross section for storing different streams of waste can be further adapted to exploit the storage capacity of the two compartments 20a, 20b enveloped in the outer body 12. In this configuration, an additional plastics liner (not shown in FIGS. 11 to 13) can be placed within the receptacle 10, where the two trilobular compartments 20a, 20b would meet back-to-back. This creates a large area of free space to both sides of the two compartments 20a, 20b, generally situated where the swept profile 60 is shown in FIG. 13. A further advantage of such configuration is that a pocket can be in-moulded in the top surface of the receptacle 10 to accommodate a roll of refuse bags.

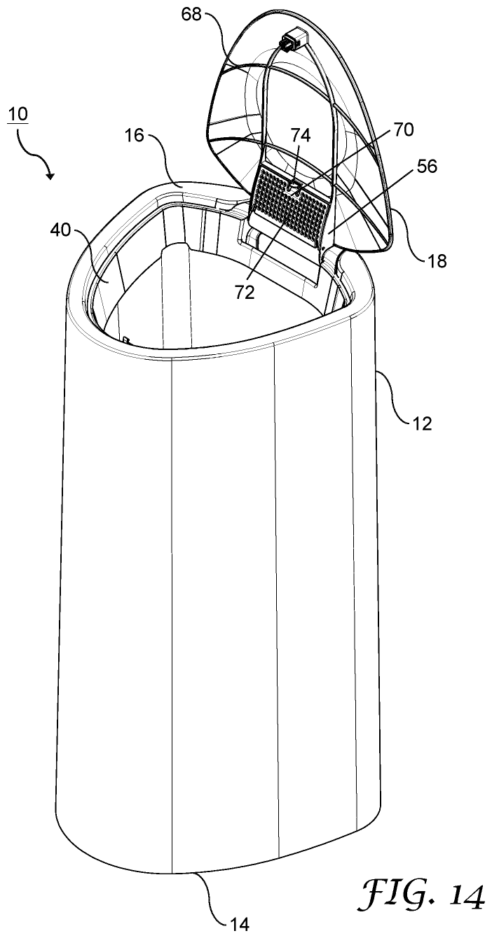

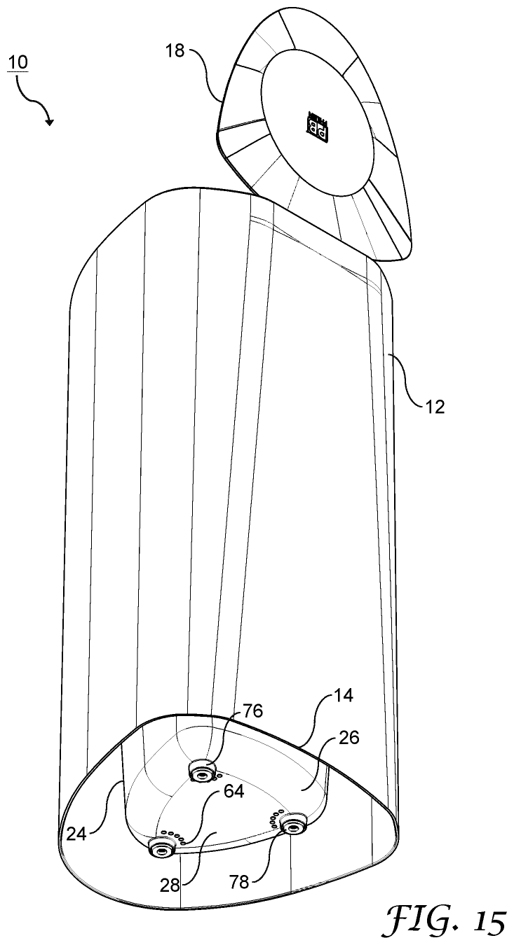

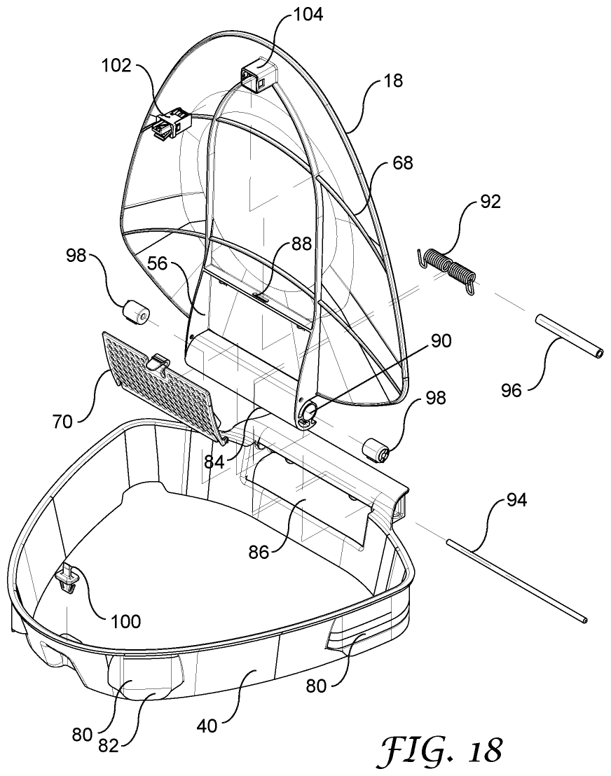

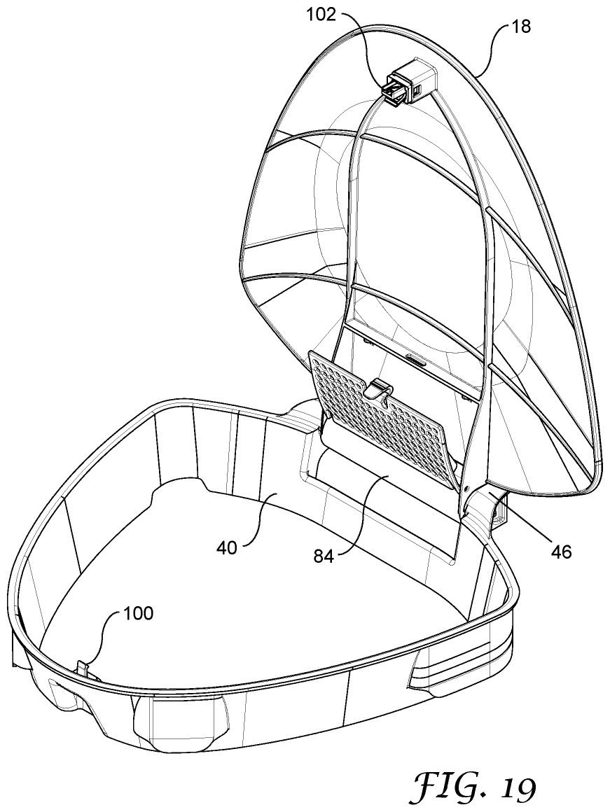

FIGS. 14 and 15 illustrate further features of the trilobular-shaped waste receptacle 10. FIGS. 14 and 15 show that the hinged lid 18, on its underside surface facing the inner compartment 20, includes a series of in-moulded strengthening ribs 68 to prevent deflection or distortion of the lid 18 when it is touched or pressed to open it, as described below in relation to FIGS. 18 and 19. The strengthening ribs 68 consist of a pattern of crossed lines on the underside of the lid 18, and are formed with the sides of the shaped pocket 56 for receiving the activated charcoal cassette 54. In the embodiment shown in FIG. 14, access to the cassette 54 is via a hinged lid 70 which includes a series of openings 72. The lid 70 is then released by urging a biased catch 74 in and out of opening 88, as best shown in FIG. 18.

FIG. 15 also shows that, in this embodiment, the receptacle 10 can be open at its base 14, instead of requiring a separate base plate 30. In this embodiment, a plurality of feet 76 extend downwardly from the base section 28 of the inner compartment 20 to provide stable frictional support when the waste receptacle 10 is placed on a surface. The feet 76 can also include a rubberised area 78 to aid friction and stability when in use.

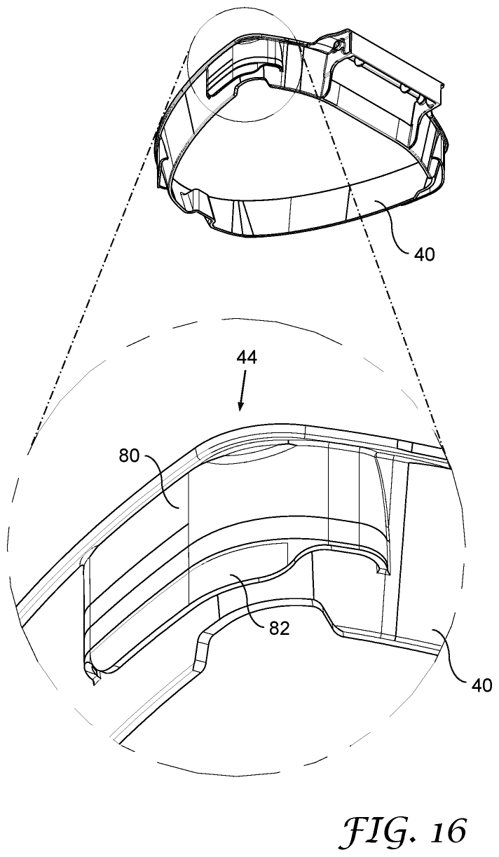

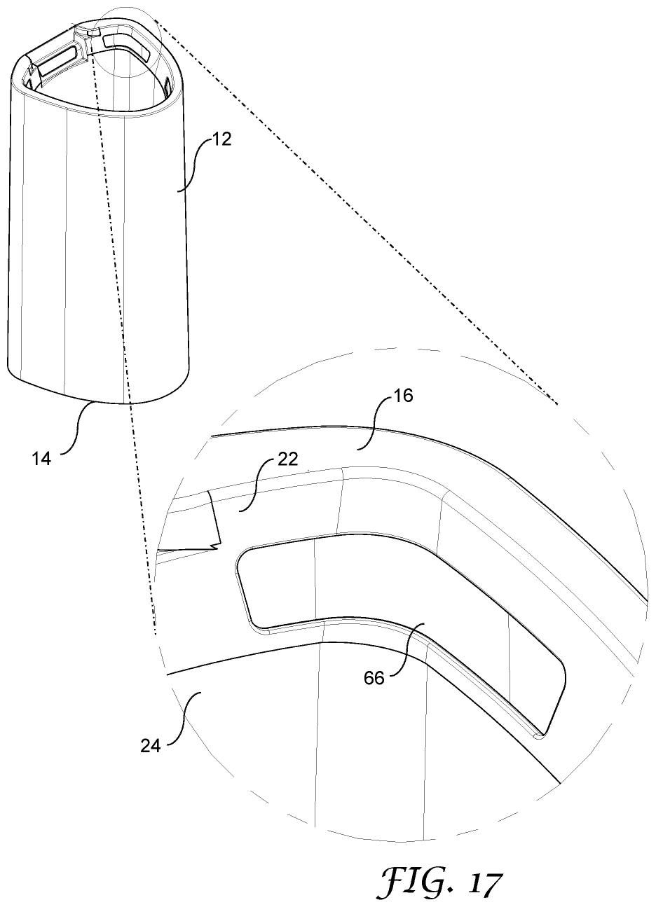

FIGS. 16 and 17 show further detail of how the retaining collar 40 is received inside the shoulder 22 of the inner compartment 20 to retain or trap the refuse bag (not shown) when in use. As shown in FIG. 16, disposed around the outer periphery of the tapered retaining collar 40, are a series of retention features 44. These retention features 44 are shaped like an inverted tab 80 and which may also include a downwardly and outwardly projecting lip 82. Each of the tabs 80 disposed around the collar 40 is dimensioned such that they are receivable inside the plurality of in-moulded slots 66 which are positioned inside the shoulder 22 of the inner compartment 20, as shown in FIG. 17. The inclusion of these retention features 80, 82 being useful for ease of emptying and replacement of the refuse bag (not shown), when the receptacle 10 is in use.

The skilled person will appreciate that the unitary construction, or integral forming, of the outer body 12, rim 16 and inner waste collection compartment 20 ensures structural stability for receiving the retaining collar 40 when in use. The unitary construction also serves to ensure that sharp edges and gaps are eliminated with the purpose of reducing the risk of damage or entrapment of the refuse bag when in use.

The unitary construction of the outer body 12, rim 16 and tapered inner waste containing compartment 20 interacting with the slots 66 and retention features 80, 82 on the retaining collar 40 provides a receptacle 10 this is able to maintain a form fitting refuse bag at all points where the bag contacts the receptacle 10, and all of which contribute to the ability of the receptacle 10 to prevent a critical failure of the bag by reducing the risk of damage when emptying or replacing the bag. When replacing a refuse bag, the in-moulded slots 66 not only allow excess refuse bag material to be gathered and tucked away, but also act to hold the opening or mouth of the refuse bag in the region of the shoulder 22 until it is more securely clamped in position by the engagement of the retention tabs 80 on the collar 40.

FIGS. 18 and 19 show further detail of how the lid 18 is receivable inside the hinge block 46 formed at the proximal end of the retaining collar 40. The proximal end of the lid 18 is formed as a rounded section 84 which is capable of rotation inside an aperture 86 formed in the retaining collar 40. An opening 90 is formed inside the rounded section 84 at the proximal end of the lid 18 which is capable of receiving a torsion hinge damper 92. One end of the helical torsion spring 92 is connected or abuts to the lid 18 and the other end is connected or abuts to the collar 40. To allow rotational movement of the lid 18, the spring 92 rotates about an axle 94 and bush 96. The damping effect of the spring 92 can be altered by torsion adjusters 98 positioned at both ends of the spring 92. Rotation of the adjusters 98 compresses or extends the spring 92 to alter the bending movement.

FIG. 19 also shows that the shape of the hinge block 46 and the complementary rounded section 84 permits the lid 18 to be positioned in a fully opened, generally 90° vertical position, to facilitate filling of the receptacle 10. In addition, when the integral lid 18 and collar 40 are to be removed to empty the refuse bag (not shown) the user simply grasps the vertically positioned lid 18 and pulls upwards to completely remove the lid 18 and collar 40 to gain unhindered access to the refuse bag.

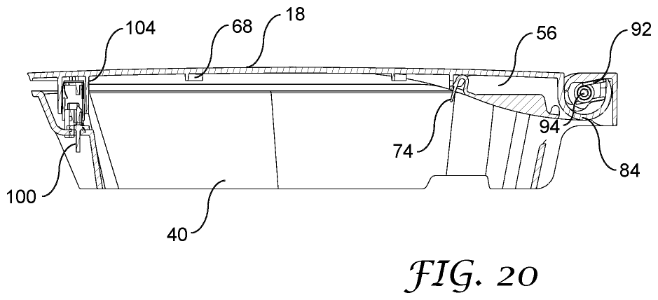

FIGS. 18 and 19 also show details of the touch lid catch mechanism 100, 102 of the present invention. As shown, one part of the catch mechanism, is a striker or projection 100 which is projects from the inside rim of the collar 40. The second part of the catch mechanism is a spring-loaded pair of arms 102 which are biased closed and can be urged apart to release the striker 100 only when the striker 100 is forced upwards between the arms 102, as occurs in use when the lid is pressed or touched. The second part of the catch 102 is retained inside an in-moulded housing 104 on the underside of the distal end of the lid 18. Further detail of the integral retaining collar 40 and lid 18, when in a closed position, is shown in FIG. 20, which is generally along the line A to A′, as shown in FIG. 1.

Various additions and alternations may be made to the present invention without departing from the scope of the invention. For example, although particular embodiments refer to manufacturing the present invention using various injection moulding techniques and having various dimensions this is in no way intended to be limiting as, in use, the present invention can be manufactured using many fabrication techniques and dimensioned in many different sizes. It will be understood that features described in relation to any particular embodiment can be featured in combination with other embodiments.

1. A receptacle comprising:
an outer body, one end of the outer body forming a base, the other end of the outer body forming a rim extending inwardly from the periphery of the outer body, and
at least one inner waste containing compartment extending inwardly and downwardly from the rim,
wherein the outer body, rim and at least one inner waste containing compartment being integrally formed, and
wherein one end of the body comprises a substantially flat continuous cross section which forms a base.

2-9. (canceled)

10. The receptacle as claimed in claim 1, wherein the inner waste collection compartment extends inwardly from the rim along an inclined shoulder which transitions to a tapered side wall that gradually narrows to a radiused corner forming a substantially flat-bottomed base.

11-31. (canceled)

32. The receptacle as claimed in claim 1, wherein the generally flat-bottomed base comprises one or more openings for receiving one or more removable drainage plugs.

33. (canceled)

34. The receptacle as claimed in claim 32, wherein the removable drainage plugs are provided as push-fit caps.

35. The receptacle as claimed in claim 1, further comprising a base plate to be retained inside the base of the body.

36. The receptacle as claimed in claim 35, wherein the base plate comprises a plurality of projections which meet with corresponding apertures disposed in the substantially flat-bottomed base.

37. The receptacle as claimed in claim 35, wherein the base plate further comprises one or more finger apertures or slots to facilitate removal and subsequent reattachment of the base plate to the base of the body.

38. The receptacle as claimed in claim 35, wherein the base plate is releasably secured to the base of the body using a fastener selected from the group consisting, but not limited to, any one of the following: circumferential screw thread, bayonet attachment, threaded fastener and clip.

39. The receptacle as claimed in claim 1,
wherein the rim defines an opening through which refuse is placed into the inner waste collection compartment in use,
wherein the opening in the body is closed off by a removable hinged lid,
wherein the removable hinged lid is integrally formed with a refuse bag retaining collar, and
wherein the refuse bag retaining collar comprises a tapered flat ring or collar which is complementary in shape to the inner waste collection compartment.

40. (canceled)

41. The receptacle as claimed in claim 39, wherein the refuse bag retaining collar comprises at least two finger grips to aid removal of the retaining collar from the receptacle in use.

42. The receptacle as claimed in claim 39, wherein the refuse bag retaining collar comprises a plurality of protrusions disposed around the outer circumference of the retaining collar, the protrusions being engageable with a complementary plurality of cut-out sections in-moulded around the inclined shoulder of the inner waste collection compartment.

43. The receptacle as claimed in claim 39, wherein the refuse bag retaining collar comprises a continuous or semi-continuous lip formed around the periphery of the retaining collar which abuts against the lid in a closed configuration.

44. The receptacle as claimed in claim 39, wherein the refuse bag retaining collar is pivotally connected to the lid by hinge means, the hinge means enabling damped pivotal or rotational movement of the lid from the closed configuration to an open configuration when a lid release catch is depressed.

45. (canceled)

46. The receptacle as claimed in claim 44, wherein the hinge means is selected from the group consisting, but not limited to, any one of the following: torsional spring arrangement, rotational coupling, rolling bearing, hinge, pivot and mechanical linkage.

47. The receptacle as claimed in claim 10, further comprising one or more horizontal slots in-moulded around the inclined shoulder of the inner waste collection compartment.

48-49. (canceled)

50. The receptacle as claimed in claim 1, further comprising a removable activated carbon filter cassette securable inside a complementary shaped retaining means formed under the hinged lid.

51-52. (canceled)

53. The receptacle as claimed in claim 1, wherein the body defines two separate and adjacent inner waste collection compartments.

54-60. (canceled)

61. A method of manufacturing, comprising the steps of:
supplying a polymer into a moulding tool which defines a receptacle, according to claim 1, said receptacle being comprised of said outer body having and said at least one inner waste containing compartment, the moulding tool including a textured surface finish on the outer surface of the body and a polished surface finish on the inner surface of the at least one inner waste collection compartment; and
ejecting the moulded receptacle from the moulding tool.

62. The method of manufacturing as claimed in claim 61, wherein the polymer is comprised of recycled polymers from both postindustrial and domestic waste streams.

63. The method of manufacturing as claimed in claim 61, further comprising the step of admixing an antimicrobial additive with the polymer.

64-65. (canceled)
